(19) United States
(12) Patent Application Publication
(10) Pub. No.: US 2014/0313345 A1
(43) Pub. Date: Oct. 23, 2014

(54) FLYING OBJECT VISUAL IDENTIFICATION SYSTEM

(71) Applicant: Ornicept, Inc., Ann Arbor, MI (US)

(72) Inventors: Russell Conard, Lafayette, IN (US); Justin Otani, Ypsilanti, MI (US)

(21) Appl. No.: 14/075,395

(22) Filed: Nov. 8, 2013

Related U.S. Application Data
(60) Provisional application No. 61/724,055, filed on Nov. 8, 2012.

(51) Int. Cl. H04N 5/232; G06K 9/00; G06K 9/32

(52) U.S. Cl. CPC H04N 5/23296; G06K 9/3233; G06K 9/00664
USPC 348/169

(57) ABSTRACT

A system for visually identifying a flying object includes a detection subsystem, a visual inspection subsystem, and an identification processor. The detection subsystem is configured to detect the location of one or more flying objects within an area, and includes at least one of radar, lidar, and visual detection. The visual inspection subsystem is configured to visually inspect an object of interest selected from the one or more detected flying objects. The visual inspection subsystem includes a camera having a field of view, a positioning system, and an image processor. The positioning system is configured to support the camera and controllably articulate the field of view to track the object of interest. Finally, the processor is configured to receive one or more images from the visual inspection subsystem, and identify a characteristic of the object of interest from the one or more images.

### CROSS REFERENCE TO RELATED APPLICATIONS

This application claims the benefit of U.S. Provisional Application No. 61/724,055, filed Nov. 8, 2012, which is hereby incorporated by reference in its entirety.

### TECHNICAL FIELD

The present invention relates generally to flying object identification systems employing visual detection and recognition techniques.

### BACKGROUND

Monitoring birds or other flying objects through visual means represents a historically resource intensive undertaking In avian studies, such an activity, however, is essential for ecological statistics. Unlike many classes of organisms that may carry out their entire life cycle within a small geographic territory, birds are, by their nature, highly mobile. Some species are particularly noted for their long annual migrations, but even species which are year-round residents can be difficult to find and accurately sample. Most avian point counts consist of human observers manually counting birds. These studies are often limited in scope and are done only at a small number of fixed locations and for very short periods of time.

### SUMMARY

A system for visually identifying a flying object includes a detection subsystem and a visual inspection subsystem. In general, the detection subsystem is configured to detect the location and/or presence of one or more flying objects within an area through at least one of radar and visual detection technology. The visual inspection subsystem is then configured to visually inspect an object of interest that is detected by the detection system and is selected from the one or more detected flying objects.

In one configuration, the inspection system includes a camera having a field of view, a positioning system, and an image processor. The positioning system is configured to support the camera and controllably articulate the field of view to track the object of interest. In general, the camera is disposed on or within a close distance of the ground, and in a manner that orients its field of view in a nominally upward/vertical direction. The positioning system, using for example, one or more motors, is then configured to articulate the field of view relative to this nominal vertical direction. Finally, the image processor is a digital device that is configured to record one or more images of the object of interest, as perceived by the camera.

The system further includes a processor in communication with the visual inspection subsystem, wherein the processor is configured to receive the one or more images, and identify a characteristic of the object of interest from the one or more images.

To select the object of interest from the plurality of detected flying objects, the system may be configured to assign a confidence value to each of the one or more detected flying objects. The camera may then be configured to track the flying object with the greatest confidence value. In one configuration, the confidence value is inversely proportional to a degree of articulation of the field of view away from a vertical axis extending from the camera that is required to visually track the object. In another configuration, the confidence value for an object is inversely proportional to a minimum absolute distance between the object and the vertical axis, together with an altitude of the object.

In one example, the object of interest may be a bird. As such, the characteristic that the processor is capable of identifying may be at least one of the family or the species of the bird. In another example, the object of interest may be an airplane. As such the characteristic of the object of interest may be at least one of the make and model of the airplane.

The above features and advantages and other features and advantages of the present invention are readily apparent from the following detailed description of the best modes for carrying out the invention when taken in connection with the accompanying drawings.

### BRIEF DESCRIPTION OF THE DRAWINGS

FIG. 1 is a schematic side view of a system for visually identifying one or more flying objects, including two visual inspection nodes.

FIG. 2 is a schematic plan view of a plurality of visual inspection nodes disposed across an area.

FIG. 3 is a schematic cross-sectional view of a visual inspection node.

FIG. 4A is a schematic plan view of a field of view of a detection node.

FIG. 4B is a schematic plan view of a field of view of a detection node.

FIG. 5 is a schematic side view of two visual inspection nodes being used to determine the altitude of a flying object.

FIG. 6 is a schematic plan view of three birds flying across a visual inspection node.

FIG. 7 is a schematic flow diagram of a method of visually identifying a flying object.

FIG. 8 is a schematic diagram of a method of using the visual identification system to determine a migratory path of a type of bird.

### DETAILED DESCRIPTION

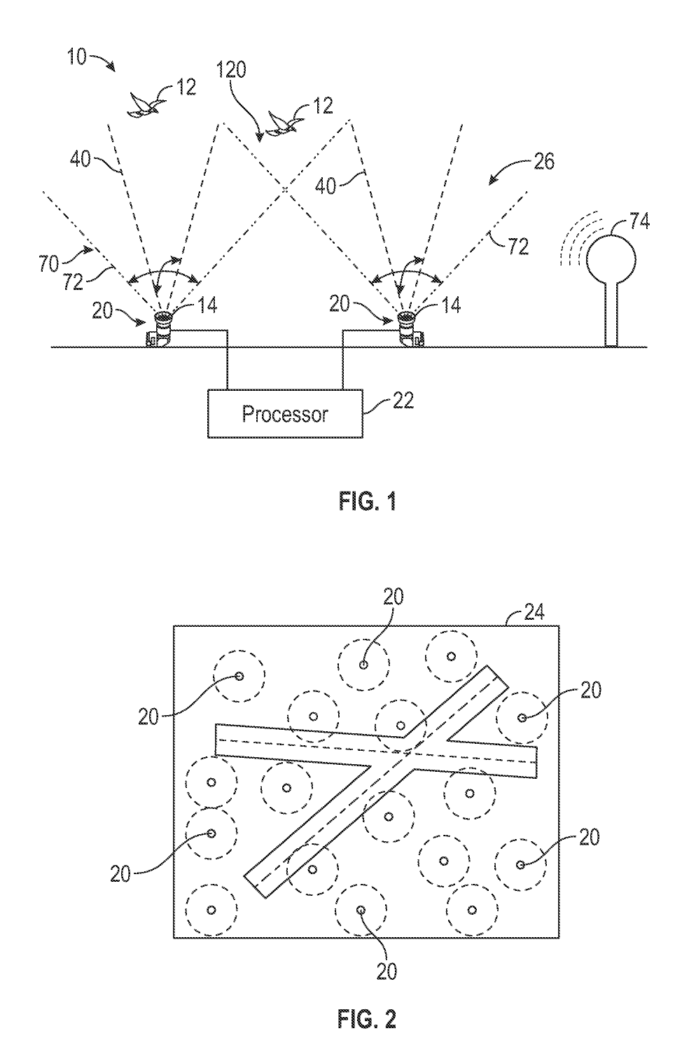

Referring to the drawings, wherein like reference numerals are used to identify like or identical components in the various views, FIG. 1 schematically illustrates a system 10 for visually identifying one or more flying objects 12. The system 10 may be a ground-based (i.e., terrestrial) system that may use one or more upward-directed inspection cameras 14 to image the underside of the flying object 12. As will be discussed below, the system 10 may use these acquired images to identify one or more characteristics of the imaged object 12, from which it may then determine nature and/or type of the object (or a parameter associated with the object, such as an altitude, speed, size, or heading). For example, if the object 12 is a bird, the system 10 may determine the genus and/or species of bird. Likewise, if the object 12 is an airplane, the system 10 may determine the make and/or model of the airplane.

In one configuration, the system 10 may be formed from one or more visual inspection nodes 20 that may be each capable of visually tracking and/or imaging the underside of a flying object 12. For example, FIG. 1 schematically illustrates an embodiment that includes two visual inspection nodes 20. Likewise, FIG. 2 schematically illustrates a plan view of an area 24 that includes seventeen visual inspection nodes 20. In general, the area 24, such as provided in FIG. 2 may be an area that spans several acres or even several square miles. For example, in one configuration, such as shown in FIG. 2, the area 24 may include an airport. In other configurations, however, the present system 10 may be used in other contexts where areal inspection is required.

In an embodiment that includes a plurality of visual inspection nodes 20, the various nodes 20 may be configured for either autonomous operation (i.e., where each node includes a local processor configured to track and/or identify a flying object 12), or coordinated operation, where identification is performed via a central processor 22 or server that is in networked communication with each node 20 and configured to aggregate acquired visual images from the various nodes 20. In general, the one or more visual inspection nodes 20 may collectively form a “visual inspection subsystem 26.”

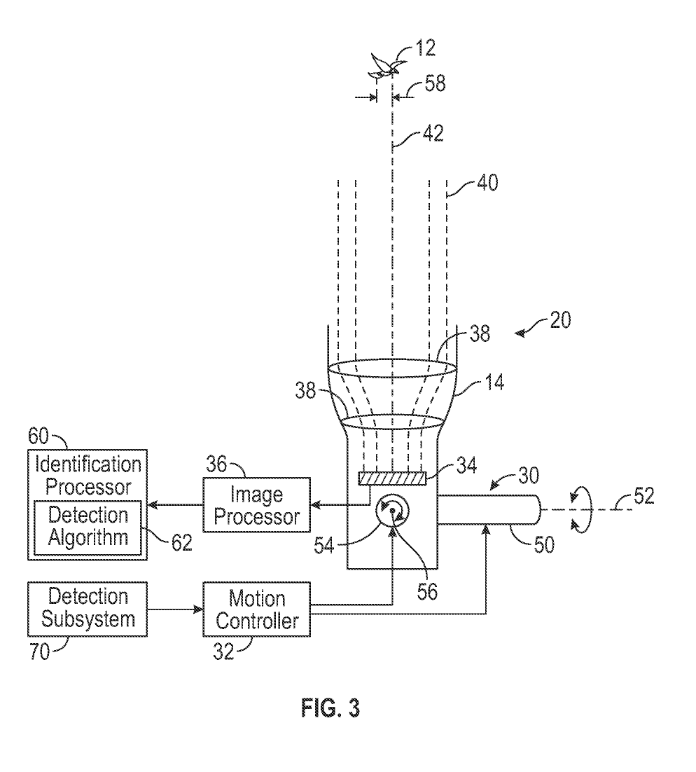

FIG. 3 schematically illustrates one embodiment of a visual inspection node 20. As shown, the node 20 includes a camera 14, a camera positioning system 30, and a motion controller 32. The camera 14 is preferably a digital camera that includes a digital image capture element 34, an image processor 36, and two or more lens elements 38. The lens elements 38 cooperate to focus light from a field of view 40 onto the image capture element 34. The arrangement of the lens elements 38 may define a camera axis 42 that is substantially centered within the field of view 40, where the camera axis 42 defines an orientation of the field of view 40 and, more generally, an orientation of the camera 14. During operation, the camera axis 42 may be nominally oriented in a vertical direction (i.e., the camera may be upward-pointing), though may be configured to articulate away from this nominal orientation at the direction of the motion controller 32.

In other embodiments, each camera in the visual inspection subsystem 26 may be a fixed camera (i.e., no positioning system 30). Such installations may be more cost effective to assemble, though may require the use of multiple nodes 20 to achieve adequate visual coverage.

In one configuration the image capture element 34 may include, for example, one or more charge-coupled devices (CCD), CMOS detectors, or other optical sensors that convert received light energy into an electrical signal. The electrical signal may be received by the image processor 36, which, in turn, may assemble one or more digital images corresponding to the field of view 40. The image processor 36 may then save/record the one or more digital images to an associated memory device either individually, or collectively as a video file. In one configuration, prior to saving the image information, the image processor 36 may scale, rotate, and/or deskew the imaged object to position it within an expected area of the frame, as well as in an expected orientation. Additionally, in one configuration, the image processor 36 may remove the background of the image to provide only the object within the frame.

To adequately perceive the various flying objects 12, the image capture element 34 may have a digital resolution of, for example, greater than about 2 megapixels. Additionally, the image capture element 34 and two or more lens elements 38 may be selected to collectively produce an adequately exposed, focused image of an object that may be located from about 40 meters above the ground to about 1000 meters above the ground. This image may involve digital and/or optical zoom such that the imaged object is represented with at least enough digital resolution to perform general edge detection.

The camera positioning system 30 may support the camera 14 and may be configured to controllably articulate the field of view 40 at the direction of the motion controller 32. The motion controller 32 may be embodied as one or multiple digital computers, data processing devices, and/or digital signal processors (DSPs) that may control the operation of one or more actuators associated with the positioning system 30. The motion controller 32 may further include power electronics and/or motor control circuitry that may generate an electrical signal with a variable voltage, current, and/or frequency. The electrical signal may then be provided to the positioning system 30 to controllably articulate the field of view 40.

In one configuration, the positioning system 30 may generally include a first motor 50 configured to articulate the camera 14 about a first axis 52, and a second motor 54 configured to articulate the camera 14 about a second axis 56. While not strictly necessary, in an effort to simplify the motion control algorithms, the first axis 52 and the second axis 56 may generally be orthogonal to each other and to the camera axis 42. In one configuration (not shown), to further simplify the motion control the first and second axes 52, 56 may also intersect at a point that is coincident with the image capture element 34.

The motion controller 32 may use a combination of open loop control, closed loop control, and/or other known object tracking algorithms to control the behavior of the first and second motors 50, 54 so that the field of view 40 dynamically tracks the flying object 12. In general, the field of view 40 may “track” the flying object 12 by attempting to maintain the flying object 12 approximately centered within the field of view 40 (i.e., it may attempt to minimize the distance 58 between the flying object 12 and the camera axis 42).

During operation, if a flying object 12 passes generally above the visual inspection node 20, the camera 14 may acquire one or more images of the underside of the object 12. These images may be passed from the image processor 36 to an identification processor 60 that may either be local to the node 20, or may be in networked communication with the node 20 (i.e., associated with a central processor 22/server). In general, the identification processor 60, image processor 36, motion controller 32, and/or any other required electronic controllers/processors may be configured as independent hardware and/or software modules, and/or may be combined into one or more integrated controllers. In one configuration, the devices/modules 32, 36, 60 may be embodied as one or multiple digital computers, data processing devices, and/or digital signal processors (DSPs), which may have one or more microcontrollers or central processing units (CPUs), read only memory (ROM), random access memory (RAM), electrically-erasable programmable read only memory (EEPROM), high-speed clock, analog-to-digital (A/D) circuitry, digital-to-analog (D/A) circuitry, input/output (I/O) circuitry, and/or signal conditioning and buffering electronics.

The identification processor 60 may include one or more image detection algorithms 62 that may visually identify one or more characteristics of the object 12 within the image. These characteristics may be used to classify the object according to at least one of a family, a genus, a species, a make, and a model. This classification may be dependent upon the amount of digital resolution, clarity, and exposure of the object within the image, but most preferably includes the most specific classification that may be determined through the available information. In addition to classifying the flying object, the identification processor 60 may also be configured to determine a flying altitude, speed, and/or heading of the object 12. The determined classification may then be recorded together with the other determined motion parameters (e.g., altitude, speed, heading, etc), or may be used to provide a real-time alert to a user. As will be discussed below, the object classification may occur using various pattern matching/image recognition techniques, such as neural network identification, Bayesian classifiers and/or the use of support vector machines.

Referring again to FIG. 1, in addition to the one or more visual inspection subsystem cameras 14 that have relatively narrow fields of view 40, the system 10 may further include a broader, flying object detection subsystem 70. The flying object detection subsystem 70 may be used to detect the presence and location of one or more flying objects 12 across an area that is wider than what is immediately visible via the field of view 40. In general, the detection subsystem 70 may provide the visual inspection subsystem 26 with a greater awareness of the various objects that may be present in the areal space above a visual inspection node 20. Using this information, the motion controller 32 may then articulate the relatively narrow field of view 40 to perceive, and/or track a particular object 12.

In one configuration, the detection subsystem 70 may include, for example, one or more vertically oriented wide-angle cameras that maintain a generally fixed view of the sky (represented in FIG. 1 by a second field of view 72 that is wider than the inspection field of view 40). In another configuration, the detection subsystem 70 may include a non-optical detection system, such as a radar system 74 instead of, or in addition to visual detection (i.e., wide angle cameras). In still other embodiments, other object detection means may be used, such as LIDAR or acoustic detection/triangulation. As used herein, the second “field of view 72” is intended to refer to the area within which an object is detectable using that respective technology, even if the object is not “viewed” in an optical sense. In an embodiment that includes a wide-angle camera, the camera may be a digital camera, such as described above, that may have a digital resolution of, for example, greater than about 2 megapixels. In one configuration, a separate wide-angle camera may be associated with each respective visual inspection node 20, and may be disposed in close proximity to or directly adjacent to the inspection camera 14. The close proximity may permit an angle of declination to an object in one camera to be approximately valid in the other camera.

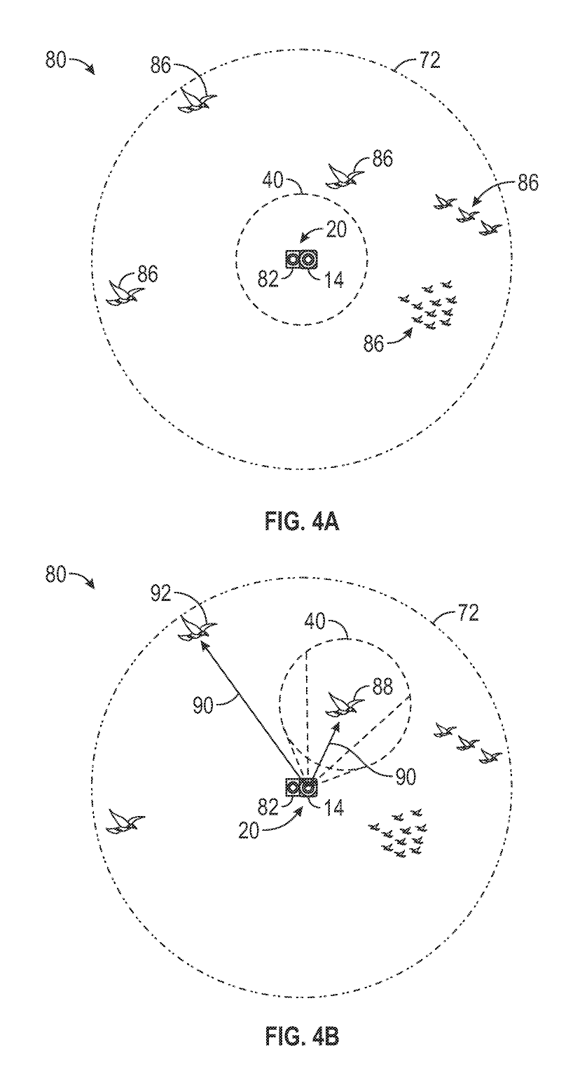

FIG. 4A schematically illustrates a plan view 80 of a visual inspection node 20 that includes a wide-angle detection camera 82. As shown, the detection camera 82 has a field of view 72 that is considerably larger than the field of view 40 of the inspection camera 14. In this manner, the detection camera 82 may have the ability to detect/perceive a plurality of flying objects 86 that are generally above the visual inspection node 20, though may be outside the instant field of view 40. Using the determined locations of each of the plurality of detected flying objects 86 within the broader field of view 7272, the motion controller 32 may then reorient the field of view 40 of the inspection camera 14 to perceive and/or track a particular object/bird of interest 88, such as shown in FIG. 4B.

In general, it has been found that the underside of a flying object presents the most consistent dataset to allow for object identification and/or differentiation between objects such as birds. To arrive at the most accurate classification when imaging a distant flying object 12, it is desirable to maximize the amount of visual information/resolution that is associated with the underside of the object 12. In this manner, for an object flying at an approximately constant altitude, the visual information is most often maximized when the particular object of interest 88 is directly above the visual inspection node 20. That is, when directly above the camera, the probability of a skewed perception is at a minimum, and the object of interest 88 is the closest to the camera (in absolute distance).

Under the goal of maximizing object resolution, the detection subsystem 70 may assign a rough confidence value to each detected flying object 12 within the broader field of view 72. The rough confidence value may vary according to at least one of an estimated size or altitude of the object, and estimated angle that the camera 14 must articulate away from a vertical axis to track the flying object 12 (i.e., how close the object is to directly vertical of the camera). Said another way, the confidence value may vary inversely with the minimum absolute distance between the object 12 and a vertical axis extending from the camera 14, together with an altitude of the object. In this manner, as illustrated in FIG. 4B, assuming a constant flying altitude for all objects, the object of interest 88 (at a distance 90) may generally be assigned greater rough confidence value then a second object 92 disposed near the perimeter of the broader field of view 72 (at a second distance 94 that is greater than the first distance 90).

In general, the motion controller 32 may direct the field of view 40 to articulate toward an object of interest 88 (selected from the plurality of detected flying objects 86) that maximizes the rough confidence value assigned by the detection subsystem 70. Following an inspection of a first object of interest 88, the motion controller 32 may then direct the field of view 40 to articulate toward a second object of interest that has the next highest assigned confidence value. Alternatively, the detection subsystem 70 may update the rough confidence values following the first inspection, though with the first object of interest 88 removed from the set of the plurality of detected flying objects 86.

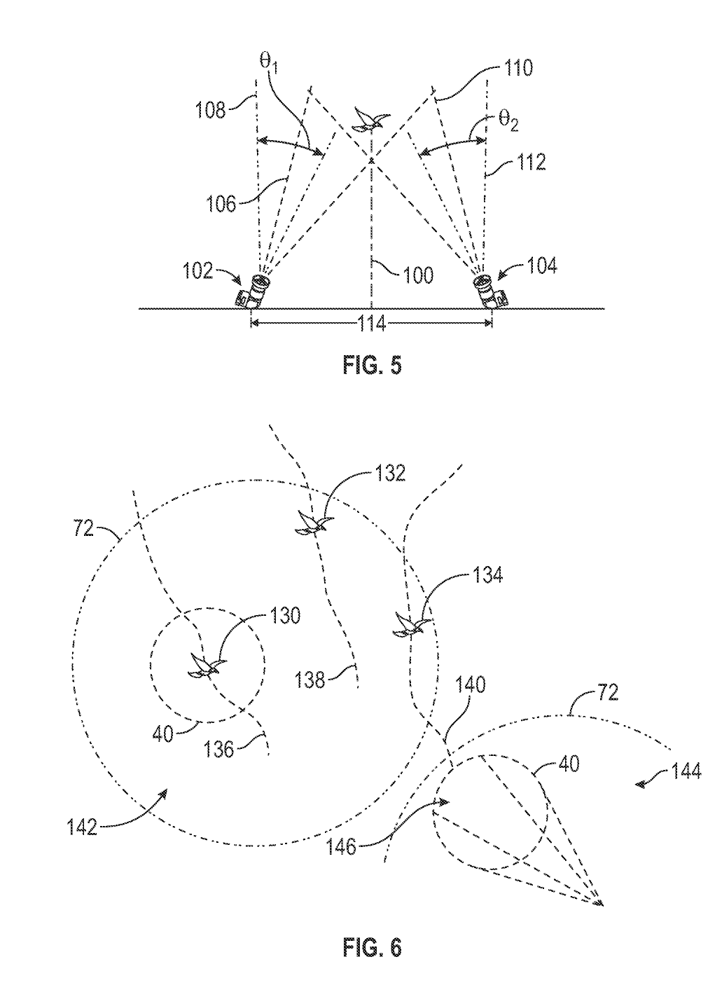

The system 10 may further be configured to determine the altitude 100 of a flying object 12, such as schematically shown in FIG. 5. In this embodiment, the altitude detection may use the coordination of two or more cameras/nodes 102, 104 that may have overlapping fields of view. For example, as shown, the first visual inspection node 102 may track the object 12 by articulating the field of view 106 of its inspection camera away from a vertical axis 108 by a first amount θ₁. Similarly, an adjacent, second visual inspection node 104 may track the same object 12 by articulating its respective field of view 110 away from a second vertical axis 112 by a second amount θ₂. Using the measured angles θ₁, θ₂ , and a known distance 114 between the two nodes 102, 104, the system 10 may determine an altitude 100 of the object 12 away from the ground 116.

In another configuration, the altitude of one or more flying objects 12 may be determined using the detection subsystem 70. For example, as shown in FIG. 1, the wide-angle cameras of adjacent inspection notes 20 may partially overlap within a region 120. If the flying object 12 is within this region 120, the altitude of the object 12 may be approximated using similar triangulation approach as described with respect to FIG. 5, albeit without physical articulation of the cameras. In a simpler embodiment, if the detection subsystem 70 uses radar or lidar, the altitude of each object 12 may be determined through the radar system itself (e.g., via an angle of inclination relative to the radar transmitter 74).

In one configuration, the central processor 16 may coordinate the behavior of the various visual inspection nodes 20 to ensure optimal detection and coverage of flying objects 12 across an area. For example, FIG. 6 schematically illustrates three flying objects 130, 132, 134, each flying on different flight paths 136, 138, 140 (respectively). As shown, a first visual inspection node 142 may focus its field of view 40 on the first object 130 (i.e., the object that is perceived to have the greatest rough confidence value for that node). At the same time, the central processor 16 may extrapolate the flight paths of the second and third flying objects 132, 134 to estimate travel into an adjacent node 144. As such, the central processor 16 may ready the second node 144 by pre-articulating its respective field of view 40 to a position 146 where object 134 is expected to enter the detection field of view 72 of the second node 144. In this manner, a node 20 may be capable of anticipating the trajectory of fast-moving objects, using recognition/pre-detection by adjacent nodes. Additionally, once the first visual inspection node 142 has sufficiently imaged the first object 130, it may then reorient to image the object with the next highest real-time rough confidence value.

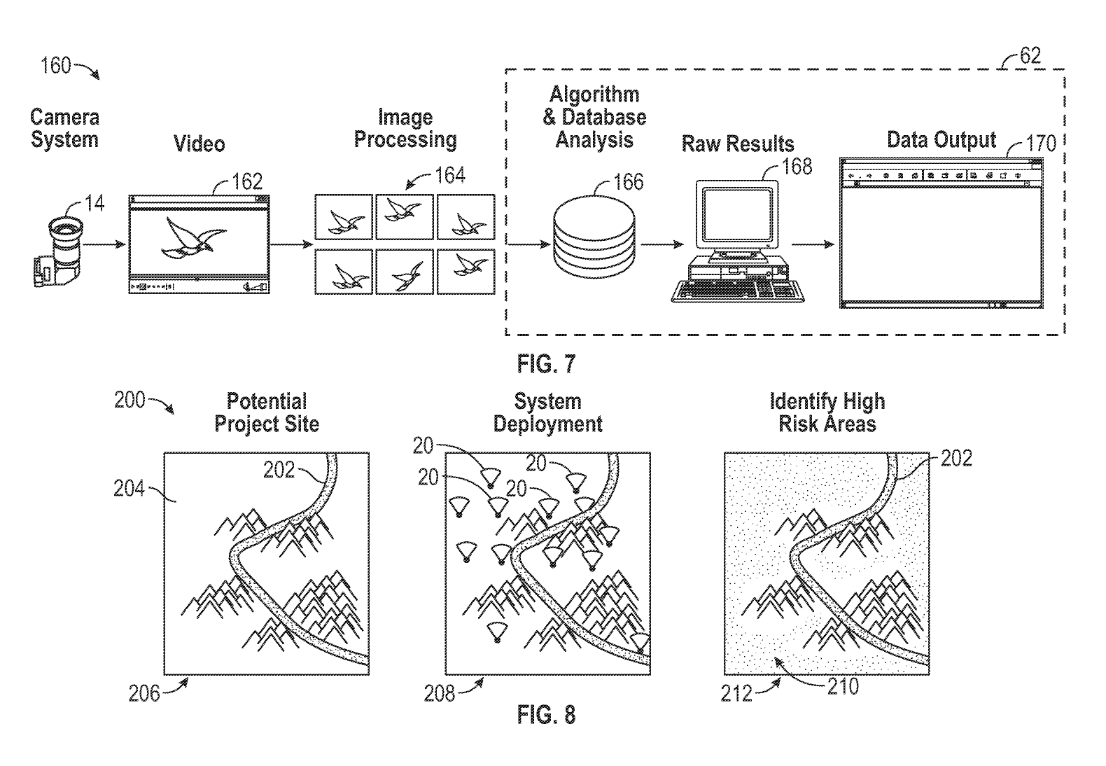

FIG. 7 schematically illustrates one configuration of a method 160 for identifying a flying object through visual detection. This method 160 may be partly performed by the identification processor 60, through one or more executed detection algorithms 62. As illustrated, image information may be initially acquired by the camera 14/image processor 36 in the form of a video feed 162. The video feed may be a continuous video feed that may then be parsed into a plurality of discrete images (at 164) (either by the image processor 36 or by the identification processor 60), and may be accessible by the detection algorithm 62. In this step, the images may also be preprocessed using scaling, rotation, deskewing, and/or background removal techniques known in the art.

Once an object is appropriately imaged by the visual inspection subsystem 26, the one or more acquired images may be processed (at 166) by the identification processor 60 to determine at least one of a family, a genus, a species, a make, or a model of the imaged object.

In one configuration, the identification processor 60 may consider multiple acquired images to make an identification in an effort to enhance the statistical confidence of the identification. Additionally, the identification processor 60 may be configured to estimate additional key information including the object's approximate height, speed, age, and direction of flight.

To accomplish the image detection, some embodiments of the algorithm 62 may utilize various forms of templating involving edge detections and feature extractions. These techniques may have difficulty differentiating, for example, similar species of birds that have very similar silhouettes, thus providing a high false positive rate.

Certain other embodiments may utilize Support Vector Machines (SVM) to quickly and accurately classify targets with many features in high dimensions. An SVM can account for each pixel in a training or unknown image sample and an SVM can be tuned for very few false positives or negatives using a robust training set.

Consistent and high quality training libraries are used in some embodiments to generate accurate results from the machine learning based object recognition algorithm. Some embodiments leave out variations in visibility and major differences in bird behavior and these aspects are accounted for later through thresholding or consecutive frames

In one configuration, the detection may begin (prior to system deployment in the field) by constructing a library of training images for objects that may be detected, which can be done through, e.g., internet collection and field collection. For large bird species that are both highly recognized and often viewed soaring, collecting from online image databases can have advantages such as being practical and time efficient. Likewise, for planes, low quality images may be readily available for some makes and models. For objects that are not generally photographed by the public, field image collection may be preferred. Additionally, for some objects, taking photos in flight from underneath can be impractical due to the erratic flight behavior. To build a robust training set, a large set of images is generally preferred. Additionally, field data collection can ensure high quality images and metadata that are highly consistent with the orientation and format that may be used in the implemented system 10, but a considerable investment of time and resources may be required.

The images in a database should ideally, but not necessarily, represent the full gamut of possible variations within certain constraints. An important aspect in some embodiments is to clearly identify what types of objects and what aspects are to be identified. For example, with birds, the SVM may be trained on the exact desired bird coloration in some embodiments to improve accuracy. This applies to many species including some where adults may exhibit regional color polymorphism or other species, such as the bald eagle which changes colors as it matures. To ensure consistent detections, these variations may be logically separated into multiple classifications.

In some embodiments, the camera 14 is capable of automatically setting the proper exposure regardless of what happens to the background sky. To at least account for situations where proper exposure is not achieved, in some embodiments the training library includes examples of a species with varying illumination to account for variations in exposure. This may have particular relevance when the difference in illumination between the sky and a target bird exceed the dynamic range of the imaging technique, which can cause the bird to either appear as a black silhouette or the sky to appear white.

In one embodiment, the image library includes negative examples of which two categories of images are included in the library of negative examples. For example, with birds, a first category of images may contain a wide variety of scenes that are clearly not birds. This category includes, but is not limited to, sky, clouds, leaves, and planes as well as bird parts such as wings, heads, and partial birds (including from the target species). These types of negative images can assist the SVM in identifying those characteristics of the bird that result in positive identification and can help eliminate hardware or other unanticipated differences between positive and negative images in the classifier. For example, including the target species in incorrect orientations and scales can eliminate possible classifications based simply on the presence of certain colors or forms regardless of composition.

The second category of negative images contains images of objects in replicate that look similar to the target objects. For example, the common black hawk, the turkey vulture, and the bald eagle all share similar visual characteristics. An SVM that has been trained for bald eagles using the other species as negative examples can be much more capable of differentiating between the species than an SVM that was trained only on bald eagle data. A large number of example species other than the target species that look similar in outline or coloration to the target species can be helpful. This can increase the accuracy of the recognition algorithm, although creating this library may appear more constraining in a testing environment.

The loose collection of images containing, for example, birds can be converted into a precise and consistent training dataset and form a canonical representation of birds compatible with an SVM input format. In general this process includes steps to crop and rotate each bird. Some embodiments use a square image dimension where the bird is consistently positioned in precisely the same manner each time, which can make the images more easily transferrable to an SVM compatible vector. The system can optionally perform an “auto toning” using, for example, various image adjustment methods known in the art to increase color contrast, or custom image manipulation code.

In situations where the target object in a training image is located near the edge of an image and the square crop includes a portion outside of the image, the transparent region can be filled with additional sky to prevent the SVM from categorizing blocked corners as being indicative of a species of bird. Filling the corner region using a sampling from the sky elsewhere in the image can be beneficial in keeping the variations in color and illumination across the background plane consistent and can help take into account the natural noise profile of images.

In situations where there is a natural variation in positioning at the wings of a bird or plane, such as when birds lift one wing slightly more than another, such as when flying to turn or to control their flight when soaring on thermals and winds, some embodiments place the center of the image sample directly on a predetermined control point, such as the point where a bird's spine meets the leading edge of the wings, which assists in developing a consistent image set. The image crop can then be extended to meet the edge of the wing furthest from the body to allow both wings to be within the crop. While embodiments employing this technique will introduce some variation between images, the overall result can allow for a degree of natural variation in testing images as long as there are sufficiently many images in the positive example training set. In this manner, the present system is particularly adept and well suited for identifying and classifying flexible form objects, such as birds or other such objects that are not formed from rigid structures.

For example, the present algorithms can have particular applicability to birds where it can detect the species of a bird given a video of its flight. By considering consecutive video frames from one camera 14, metadata about a bird's trajectory, altitude, and flying conditions can be computed. When video from multiple cameras is considered in aggregate, inferences about movement, population dynamics, and behavior can be inferred. Embodiments of the inspection node 20 include a camera 14 that can be remotely deployed to allow for remote sensing of flying objects. Such a node 20 may further incorporate a computer, solar panels, cameras, batteries, and an environmental housing. This device can be deployed in solo or in aggregate to provide environmental surveys.

Additionally in the image processing step at 164, some embodiments use a technique to check an image using an SVM at each scale and rotation. Although this can be cumbersome, it is effective. The process of subsampling the image at every rotation and scale can be time and memory intensive, especially when applied to a series of video frames for detection. In other embodiments, an algorithm traverses the subsampling routine utilizing a cascading algorithm. Using various levels of screening and analysis, the algorithm can achieve detection across scales and rotation by sampling only those regions with the highest likelihood of recognition.

After preprocessing and bounding the image, in step 166 the image is screened for detection peaks, such as by using a linear SVM classifier. Performing a two dimensional cross correlation of the image at each scale with a linear SVM quickly finds regions with high likelihoods of recognition. This technique leverages the prior knowledge computed from the training image library and works very quickly. Some embodiments find local maxima of this screening and apply a Radial Basis Function (RBF) SVM or other stronger kernels to enhance accuracy. Rather than applying brute force techniques, the linear SVM screens are analyzed by rotation and scale, intelligently sampling the source image at each stage requiring a fraction of the samples that may otherwise be necessary. In some embodiments, these samples are, after being then processed through the RBF SVM, assigned confidence values for detection. In some embodiments, rotation and scale are then composited together into a multi-dimensional map of the image, and the SVM outputs can be reoriented to form a precise map of the source image including metadata on scale, rotation, and confidence. This technique can have advantages over simple edge detection or templating techniques, which can have a tendency to have many false positives in real-world computer vision data.

Some embodiments utilize a linear SVM application to quickly determine image regions with a higher likelihood for containing the target. These regions can be screened later after, for example, applying a generous threshold. To facilitate this process, an edge detection method can be applied to the image before screening. Despite some of the weaknesses of edge detection algorithms, they can still be acceptable at this early stage and can facilitate the linear SVM by considering only outlines.

In some embodiments the linear SVM is applied across image scales by running a two dimensional cross-correlation on the image, resizing the image, and repeating this process a desired number of iterations. Rotation can be accomplished by rotating the image and applying a two-dimensional cross-correlation. Some embodiments can improve memory usage of this method by rotating the SVM matrix rather than the image itself, but this can have a side-effect of marginally lowering the responses at non-perpendicular orientations. This can be an acceptable tradeoff in many cases, but in other cases it may be preferable to preserve the full response potential for species that are more challenging to detect.

Confidences can be somewhat challenging to determine for linear SVMs. To compensate for this, some embodiments utilize a system for determining pre-calculated cutoff values, which appears to be more efficient and effective than embodiments applying scaling and thresholding across scales and rotations.

In some embodiments, each image in the training dataset is cross-correlated with the trained linear SVM, and the results are calculated and stored. The mean value of this set can comprise an expected value for a positive detection. However, to account for potential inadequacies of applying a machine learning algorithm to its own training data, this value may be used only for reference in some embodiments. The standard deviation of training set correlations may also be calculated, and the calculated cutoff value can be computed as the expected value less a multiple of the standard deviation. A large number of training images can assist in preventing over-fitting, and the multiple used to vary the cutoff can be verified during supervised testing runs.

Some embodiments utilize a Radial Basis Function (RBF) Support Vector Machine kernel algorithm for classification based on a number of features, which can achieve a greater degree of detail necessary to differentiate between similar species. Support vector machine packages can be used to compute confidence values for samples when using an RBF kernel, and these values are later used in some embodiment to determine the likelihood and location of birds in the given image.

Embodiments using linear SVM techniques can have speed advantages over more complex kernels, but can have reduced detection abilities compared to embodiments using other techniques. Linear SVMs have the capability of rapidly running over a testing image as they rely simply on a dot-product computation. Therefore, in some embodiments an image is scanned through a fast two-dimensional cross-correlation, rather than running samples through a more complex kernel based classification algorithm as in other embodiments. This allows for a detection stack to be quickly calculated that indicates the likelihood of a target occurring over a series of scales and rotations. This stack can then be referenced as a lookup table for sampling an image for processing using a more precise kernel later.

Some embodiments utilize a gradient mapping tool to preserve a high level of detail and utilize the large feature space capabilities of the RBF kernal. Although some embodiments utilize edge mapping tools, it was discovered that data was being discarded by edge mapping. As such, some embodiments utilize a raw gradient map, which was discovered as being more effective in some situations. Although a number of gradient mapping techniques may be utilized, certain advantages were realized using a cross-correlation with a 3×3 magic square. This methodology can obtain a gradient map with a consistent histogram. By utilizing a video stream and rotational data from the cameras, significant improvements can be made in detection. For example, by using motion data, the speed, orientation, and/or altitude of the target can be inferred, which may further simplify the feature extraction process.

In some embodiments, photos of the objects against a sky are prescreened by temporarily removing slowly changing regions of the video. By manipulating and sampling only regions with dark forms, memory intensive actions such as rotation and detection can be performed on smaller images. This can provide faster object recognition, and the size of the extracted forms can later be used in some embodiments to determine the approximate size of the target based on, for example, the species detected and lens angular view.

Embodiments of the present disclosure can use one or more of the following techniques:

Screening: As was discussed earlier, some embodiments use a pre-trained linear SVM to screen an image using a two-dimensional cross correlation. Given a matrix trained for each species, a detection map is generated for the image at each rotation and scale. These image maps are thresholded using the previously discussed positive detection metric, and a lookup table can be created for a more thorough screening later. In some embodiments, the source image is sampled at each scale and rotation at each location designated in the screening stage and output in SVM parsable matrices. This can be accomplished using conditional loops based on screening results. To facilitate efficient classification and assist parallel processing, it was found to be effective to store image samples in a queue for later processing, which is done in some embodiments.

SVM Analysis: An SVM algorithm can be employed for classification, which allows for probability estimates to be calculated at each point by logistic regression. When considered at multiple rotations, scales, and video frames, a probabilistic model can be applied to infer the position and trajectory of a target in certain embodiments.

Data Contraction: Some embodiments consider multiple possible target scales within an image, and some of these embodiments rescale each of the resultant images to a uniform scale for comparison. To retain accuracy, some embodiments upscale each scale up to the size of the largest scale using nearest-neighbor or bicubic interpolation, which can assure that no data is lost or distorted during the conversion process. During this stage, data can be recorded on target scale, location, rotation, and confidence. Often, a target will be detected at different scales and rotations and some embodiments prioritize data with higher probability estimates.

In some embodiments, one species is divided into multiple target specimens for the purpose of identification for training and classification. This may be useful in identifying species such as bald eagles, which go through changes as they progress through the maturation process. This level of specificity in the training set may be beneficial in determining the age of birds when maturation is defined by appearance and in reducing the false positive rate.

Detection Confidence:

Probability estimates are optionally stored for every point analyzed by the RBF SVM. These estimates can be thresholded to determine whether a target species was accurately detected to output images as shown in the previous set of results. For each image, these probability estimates may be stored and all values above the threshold can be converted, optionally to a consistent color such as white for illustrative purposes.

Scale and Rotation Detection: In many images, strong probability estimates are found at one discrete rotation and scale. It is then possible to infer the direction and altitude of the target bird. In some cases, a bird will occur between two scales and will be detected at multiple levels.

Video Data: The algorithm in some embodiments is used to analyze still images; however, alternate embodiments analyze video data. With consecutive frames at known time intervals, probabilistic models are built on top of the video data to determine additional data about species, direction, velocity, and altitude. By optionally using Hidden Markov Models, noisy data found in each image is filtered (using Kalman Filters for example). This information provides additional metadata and more robust results for analysis. Analyzing video data can have particular applicability for field research. Remote sensing cameras are optionally placed at point count locations, and a computer station analyzes video data collected. The data feeds can consist of video recordings made of targets flying overhead, and a video optimize algorithm can be used to handle data collection.

Inter-Camera Sampling Models: As generally shown in FIGS. 1, 2, and 6 camera installations across an area 24 can optionally be set up in a network of interconnected nodes 20. Data from each node 20 can be analyzed to determine the movement and identity of flying objects and/or to determine the movement of the objects across the entire area 24. For example, a bird flying north from a first node 20 at 20 km/h may pass over another node 20 0.5 km to the north 1.5 minutes later. By computing the potential trajectories of birds, a single target can be tracked across an area 24, providing additional information on bird movement and species behavior. Embodiments using algorithms to determine the potential movement of a given bird across the area 24 based on node data can be very helpful in determining bird population dynamics. These embodiments can optionally account for curved flight patterns, geographic obstacles, and models based on previous flights.

Still further embodiments determine an object's altitude such as by using known width of the object's wingspan, the width of the object in the image, and the lens' field of view.

In one embodiment, the proposed algorithm accurately identifies diurnal birds using optical cameras in field environments. By using a cascading machine learning system in one particular embodiment, the algorithm is able to perform radial basis function support vector machine classifications across images in a more manageable amount of time than brute force approaches, and detections can be run across a range of rotations and scales to determine the orientation and altitude of the target bird. When used in conjunction with robust training sets, this algorithm can differentiate between the target species and species with similar appearances. Still further embodiments interpret data between frames and between camera nodes, allowing for more capable mapping of the movements of birds.

Embodiments include algorithms that can be tuned to different levels of specificity and speed. These algorithms have been written so that by adjusting a few parameters, they can compute on a lightweight, battery operated laptop with limited memory or on a parallel computing cluster with nodes running video frames concurrently and interpreting them back together.

In one embodiment, a linear SVM, a simple edge detection algorithm is used to map each scale of the image in a first screening. A mapping algorithm for the final, precise stage includes a formulation of simultaneous edge detections and a formula for leveling the background plane for analysis, which is also effective when used in conjunction with an RFB SVM across various luminances and image qualities. A Hidden Markov Model style filtering is then applied to outputs to obtain tracking information across video frames. This allows for tracking a target between frames while accounting for uncertainty. Coupled with a probabilistic model to determine detection confidence between multiple frames, such a system can robustly determine the identification and behavior of a tracked target. By combining a number of training sets, the system can identify multiply target classes and identities.

Embodiments of the present disclosure can use one or more of the following components:

Tuning the SVM using an iterative deepening depth-first search methodology. This method can improve the accuracy of the SVM by tuning the parameters of the support vector machine's separation computations. This method is specific to computer vision applications and streamlines iterative preprocessing steps depending on the parameters of the grid search.

A kernel based image rotation algorithm, which can speed up the repetitive rotation of images using a pre-computed kernel. This can allow for a series of images to be rotated identically and to be uniformly rotated more quickly than traditional methods.

A color channel search which can optimize the grayscale conversion of color images. The algorithm can perform a grid based, iterative deepening depth-first search that varies the composition of red, green, and blue weights in grayscale images to maximize the amount of relevant detail that can be extracted.

A method for standardizing the luminance and response of images to process photos where an object is photographed against the sky. This method balances the red, green, and blue channels to neutralize the background planes from each channel.

As described above, at least one embodiment collects video using a hardware based camera system, then analyzes the video using a software system to classify the species of the bird. Various embodiments can utilize one or more of the following optional techniques.

Template Matching: In some embodiments, identification is accomplished by performing preprocessing techniques to define a bird image as a discrete map that can be compared to a template. By comparing each bird map with a database of species maps, a bird is identified. For example, in one embodiment an incoming bird image is edge mapped, for example, using a Sobel method. This edge map can then be compared to a database of species Sobel maps using, for example, a K-nearest neighbor classification algorithm.

Eigenfaces Style Approach: In some embodiments an eigenfaces method is used and one or more databases of training images are fed through a vector principal component analysis. With the precomputed set of principal vectors (eigenfaces), any new bird form can be decomposed into this finite set of vectors. For example, a set of training images for multiple bird species can be fed into a vector principal component analysis, and a finite set of eigenvectors representing birds can be created. Each species of bird would then be classified as a representation of these eigenvectors. When a bird is identified using this technique, it is broken into its principal vectors and compared to the database of known eigenvectors.

Cascading Approaches: In some embodiments, a cascading algorithm is used to efficiently perform recognition problems, which can be computationally costly if not managed. Using this approach, an imprecise initial classifier is first applied to screen test cases. Samples identified during the initial screening process are then more rigorously screened using a stronger classifier. This helps to eliminate the need to strongly classify cases in which there is a low probability of a match. In certain embodiments, a linear SVM is used to screen targets and a radial basis function SVM is used for more thorough classification.

Boosting Approach: In some embodiments, a number of efficient, weak classifiers are used in conjunction with one another to form a stronger classifier. For example, a combination of the above-listed methods can be implemented along with other, weaker classifiers to make stronger determinations.

Once the analysis in step 166 is performed (i.e., using one or more of the techniques described above), the raw results may be output at 168, and categorized by frequency, size, or flight path in step 170.

FIG. 8 schematically illustrates a schematic method 200 of using the above-described system 10 to identify a bird migration path 202. As shown, the area of interest 204 may be selected at 206 to perform the detection. In this configuration, the area of interest 204 may be a portion of a country side, for example, where a wind turbine farm is targeted to be constructed. In the embodiment provided in FIG. 2, the area of interest 24 may be an airport.

Once the area 204 is selected at 206, a plurality of visual inspection nodes 20 may be placed within the area 204 such that the respective fields of view 40 provide an optimal coverage of the sky (at 208). In one configuration, such placement may involve determining an optimal placement of the nodes, such as using a quantitative optimization routine that maximizes the distance between respective nodes 20. This optimization may be performed using various constraints that restrict placement of nodes 20 within certain portions of the area (e.g., on an airport runway, or at the peak of a mountain). The user may physically place each node 20 (as specified via the optimization) with the inspection camera 14 aligned in a nominally vertical direction (i.e., where nominally vertical means that the camera axis 42 is aligned along a vertical direction and is capable of articulating relative to the vertical axis).

Once the visual inspection nodes 20 are properly positioned, the system 10 may then be operated, such as described above and with reference to FIG. 7. In this manner, the system 10 may identify the speed, heading, altitude, and flight path of various birds, while categorizing such parameters by bird family, genus, or species. The system 10 may then, for example, display for a user a density map 210 that corresponds to some or all of the acquired data (at 212). Once the data is acquired, the system may estimate a general migratory path 202 based on frequency and/or path information of various birds from the acquired object data. Likewise, the system 10 may be configured to filter all of the identified flying objects to show merely those of a particular species and that are flying at an altitude of between about 40 meters and about 250 meters (i.e., an altitude that is potentially affected by the turbine blades).

While the best modes for carrying out the invention have been described in detail, those familiar with the art to which this invention relates will recognize various alternative designs and embodiments for practicing the invention within the scope of the appended claims. It is intended that all matter contained in the above description or shown in the accompanying drawings shall be interpreted as illustrative only and not as limiting.

1. A system for visually identifying a flying object, the system comprising:
a visual inspection subsystem configured to visually inspect an object of interest disposed at an altitude above the ground, the visual inspection subsystem including:
a camera having a field of view;
an image processor configured to record one or more images of the object of interest; and
a processor in communication with the visual inspection subsystem, wherein the processor is configured to:
receive the one or more images; and
identify a characteristic of the object of interest from the one or more images.

2. The system of claim 1, wherein the visual inspection system further includes a positioning system configured to support the camera and controllably articulate the field of view to track the object of interest; and

3. The system of claim 2, further comprising a detection subsystem configured to detect the location of one or more flying objects within an area greater than the field of view of the camera, the detection subsystem including at least one of radar, lidar, and visual detection; and
wherein the object of interest is selected from the one or more flying objects detected by the detection subsystem.

4. The system of claim 3, wherein the visual inspection subsystem is configured to assign a confidence value to each of the one or more flying objects detected by the detection subsystem;
wherein the confidence value is inversely proportional to a degree of articulation away from the vertical direction that is required to track the respective flying object within the field of view; and
wherein the object of interest is selected to maximize the confidence value.

5. The system of claim 3, wherein the detection subsystem is a visual detection subsystem including a second camera that has a field of view greater than the camera of the visual inspection subsystem.

6. The system of claim 3, wherein the visual inspection subsystem includes a plurality of cameras distributed about the area;
wherein each camera includes a respective field of view that is controllably articulated by a respective positioning system to track the object of interest.

7. The system of claim 6, wherein the detection subsystem is a visual detection subsystem including a plurality of cameras, each having a respective field of view;
wherein each of the plurality of cameras of the visual inspection subsystem is paired with a respective camera of the detection subsystem; and
wherein, for each camera pair, the field of view of the detection subsystem camera is greater than the field of view of the visual inspection subsystem camera.

8. The system of claim 7, wherein the field of view for each of the plurality of cameras of the detection subsystem and of the visual inspection subsystem is nominally oriented in a vertical direction.

9. The system of claim 8, wherein the field of view for each of the plurality of cameras of the detection subsystem is fixed relative to the vertical direction; and
wherein the field of view for each of the plurality of cameras of the visual inspection subsystem is configured to articulate relative to the vertical direction.

10. The system of claim 1, wherein the visual inspection subsystem is a terrestrial system; and
wherein the field of view of the camera is nominally oriented in a vertical direction; and
wherein the positioning system is configured to articulate the field of view relative to the vertical direction.

11. The system of claim 1, wherein the object of interest is a bird; and
wherein the characteristic of the object of interest is at least one of a family or a species.

12. The system of claim 1, wherein the object of interest is an airplane; and
wherein the characteristic of the object of interest is at least one of a make and a model of the airplane.

13. A system for visually identifying a flying object, the system comprising:
a detection subsystem configured to detect the location of one or more flying objects within an area, the detection subsystem including at least one of radar, lidar, and visual detection;
a visual inspection subsystem configured to visually inspect an object of interest disposed at an altitude above the ground, wherein the object of interest is selected from the one or more flying objects detected by the detection subsystem, the visual inspection subsystem including:
a camera having a field of view;
a positioning system configured to support the camera and controllably articulate the field of view to track the object of interest; and
an image processor configured to record one or more images of the object of interest; and
a processor in communication with the visual inspection subsystem, wherein the processor is configured to:
receive the one or more images; and
identify a characteristic of the object of interest from the one or more images.

14. The system of claim 13, wherein the visual inspection subsystem is configured to assign a confidence value to each of the one or more flying objects detected by the detection subsystem;
wherein the confidence value is inversely proportional to a degree of articulation away from the vertical direction that is required to track the respective flying object within the field of view; and
wherein the object of interest is selected to maximize the confidence value.

15. The system of claim 13, wherein the detection subsystem is a visual detection subsystem including a second camera that has a field of view greater than the camera of the visual inspection subsystem.

16. The system of claim 13, wherein the visual inspection subsystem includes a plurality of cameras distributed about the area;
wherein each camera includes a respective field of view that is controllably articulated by a respective positioning system to track the object of interest.

17. The system of claim 16, wherein the detection subsystem is a visual detection subsystem including a plurality of cameras, each having a respective field of view;
wherein each of the plurality of cameras of the visual inspection subsystem is paired with a respective camera of the detection subsystem; and
wherein, for each camera pair, the field of view of the detection subsystem camera is greater than the field of view of the visual inspection subsystem camera.

18. The system of claim 17, wherein the field of view for each of the plurality of cameras of the detection subsystem and of the visual inspection subsystem is nominally oriented in a vertical direction.

19. The system of claim 18, wherein the field of view for each of the plurality of cameras of the detection subsystem is fixed relative to the vertical direction; and
wherein the field of view for each of the plurality of cameras of the visual inspection subsystem is configured to articulate relative to the vertical direction.

20. The system of claim 13, wherein the visual inspection subsystem is a terrestrial system; and
wherein the field of view of the camera is nominally oriented in a vertical direction; and
wherein the positioning system is configured to articulate the field of view relative to the vertical direction.

21. The system of claim 13, wherein the characteristic of the object of interest is at least one of a family, species, a make, and a model of the object of interest.
